(19) United States
(12) Patent Application Publication
(10) Pub. No.: US 2012/0049136 A1
(43) Pub. Date: Mar. 1, 2012

(54) CONDUCTIVE POLYMER FILM, ELECTRIC DEVICES AND METHODS FOR MANUFACTURING THE CONDUCTIVE POLYMER FILM

(75) Inventors: Takeshi SANO, Takatsuki-city (JP); Makoto SHIRAKAWA, Kusatsu-city (JP); Gaku HARADA, Kawanishi-city (JP)

(73) Assignee: SANYO ELECTRIC CO., LTD., Moriguchi-city (JP)

(21) Appl. No.: 13/220,878

(22) Filed: Aug. 30, 2011

(30) Foreign Application Priority Data
Aug. 30, 2010 (JP) 2010-192775

(51) Int. Cl. H01B 1/12; B05D 5/12

(52) U.S. Cl. 252/519.33; 252/500; 427/58

(57) ABSTRACT

Conductive polymer films are provided having excellent conductivity. Electronic devices made from the films and manufacturing methods of the conductive polymer film also are provided. The conductive polymer films are obtained from polymerization liquid that includes monomers of a conductive polymer, an oxidizer, an alcoholic solvent, and an aromatic solvent contained in the polymerization liquid in the proportion of 1 to 50 percent by mass of the total solvent for polymerization. The aromatic solvent contains, as a substituent group of an aromatic ring, an alkyl group with a carbon number of 1 to 10 and/or an alkoxy group with a carbon number of 1 to 10, but lacks a hydroxyl group.

### CROSS REFERENCE TO RELATED APPLICATIONS

This application of the invention entitled “CONDUCTIVE POLYMER FILM, ELECTRIC DEVICES AND METHODS FOR MANUFACTURING THE CONDUCTIVE POLYMER FILM” is based upon and claims the benefit of priority under 35 USC 119 from prior Japanese Patent Application No. 2010-192775, filed on Aug. 30, 2010; the entire contents of which are incorporated herein by reference.

### BACKGROUND OF THE INVENTION

1. Field of the Invention

The claimed invention relates to a conductive polymer film, electric devices and methods for manufacturing the conductive polymer film.

2. Description of Related Art

Unlike plastics and other polymer materials generally known as insulators, conductive polymers conduct electricity and generally exhibit intermediate conductance (electrical conductivity) between that of insulators and metals. Conductive polymers have characteristics of being flexible and light while still being electrically conductive.

Conductive polymers have been placed into practical use as antistatic coatings, solid electrolytic capacitors, and the like. In order to expand the application of conductive polymers, developments of materials for conductive polymers that readily actualize even higher conductivity and manufacturing methods of such conductive polymers are required.

Conductive polymer films have an excellent flexibility. Further, conductive polymer films are durable against bending, and are formable at low temperature. Accordingly, conductive polymer films may be adopted for super-lightweight, thin devices that use plastic films as base materials. Research has been conducted on applying conductive polymers in such fields as organic electroluminescent devices (organic EL devices), actuators, transistors, organic solar cells, electrodes for dye-sensitized solar cells, capacitors, other batteries, sensors, and anti-rust materials.

Conductive polymers of improved conductivity may be used to prevent static buildup as are used conventionally. Also, such conductive polymers may be used for forming a conductive layer in solid electrolytic capacitors, capacitors of other types, and the like, so that resistance in the conductive layer can be lowered. Consequently, performances of these devices may be improved. Particularly, improvement in conductivity of the conductive polymer layer is critical for solid electrolytic capacitors because the conductivity improvement may lower the internal resistance known as equivalent series resistance (ESR.)

Various materials such as polyacetylene, polyaniline, polypyrrole, polythiophene, Poly(p-phenylenevinylene), polyfluorene, and derivatives or copolymers of these substances are known materials for conductive polymers. The polymer of any above-mentioned material has a special electron configuration known as the n-electron conjugated system, and has certain conductivity. Amongst the above-mentioned materials, polyethylenedioxythiophene (PEDOT) has a stable molecular structure and its electrical conductivity and heat resistance provides a basis for potential improvements in obtaining materials having high conductivity.

Conductive polymers are required to have as high conductivity as possible. To improve the conductivity, various kinds of dopants and additives have been studied. Such additives may be organic solvents, basic compounds, and acidic substances.

Japanese Patent Application Publication No. Hei 8-48858 shows a technique in which an organic solvent such as N-methylpyrrolidone or ethylene glycol is added to a conductive polymer containing polythiophene and polyanion.

Japanese Patent Application Publication No. 2007-95506 shows techniques of applying a conductive polymer coating containing a conductive polymer and polyanion with an addition of a basic electrical conductivity improver. Japanese Patent Application Publication No. 2008-171761 and a non-patent document “Advanced Functional Materials” (2004, vol. 14, p. 615) show techniques of oxidative polymerization of monomers of a conductive polymer where a basic electrical conductivity improver is added to the monomers.

Japanese Patent Application Publications Nos. 2004-107552 and 2008-34440 show techniques of oxidative polymerization of monomers of a conductive polymer, in which acidic additives such as a p-toluenesulfonic acid and an aromatic dicarboxylic acid are added.

The electrical conductivity σ of a conductive polymer is represented by the equation σ=enμ, where e is an electric charge, n is carrier density, and μ is mobility. Accordingly, the electrical conductivity can be increased by increasing the carrier density and the mobility. Increasing the amount of dopant is essential to increase the carrier density, while improving the orientation of the conductive polymer is essential to increase the mobility.

However, techniques shown in Japanese patent publication Nos. Hei 8-48858 and 2007-95506 have a problem of inability to improve the orientation of the conductive polymer because additive treatment is performed after formation of the conductive polymer. Techniques taught in Japanese patent publication Nos. 2004-107552 and 2008-34440 also have drawbacks. When the pH of the oxidative-polymerization liquid is lowered, the speed of reaction generally increases. Therefore, when an acidic additive is added to the monomers of the conductive polymer, less oriented resultant conductive polymer film is obtained. Hence, these techniques from related art do not improve orientation of the conductive polymer film. Accordingly, no significant improvement in the electrical conductivity can be obtained as efficient movements of carriers within a single molecular chain or from one molecular chain to another are inhibited.

In Japanese Patent publication No. 2008-171761 and the above-mentioned non-patent document “Advanced Functional Materials,” the polymerization reaction speed is decreased by adding a basic additive. Thereby a highly oriented conductive polymer film may be obtained. However, the addition of a basic substance, slows the reaction, which makes it difficult to form a conductive polymer film with sufficient thickness.

### SUMMARY OF THE INVENTION

The claimed invention provides a conductive polymer film of excellent conductivity, an electronic device using the same, and a manufacturing method of the conductive polymer film.

An aspect of the invention provides a conductive polymer film obtained from a polymerization liquid that includes monomers of a conductive polymer, an oxidizer, an alcoholic solvent, and an aromatic solvent contained in the polymerization liquid in the proportion of 1 to 50 percent by mass of the total solvent, wherein the aromatic solvent contains, as a substituent group of an aromatic ring, an alkyl group with a carbon number of 1 to 10 and/or an alkoxy group with a carbon number of 1 to 10, but lacks a hydroxyl group. Note that a “solvent” here means a liquid that solves at least monomers and an oxidizer. Further, the “total solvent” refers to a total of solvents that are used in the polymerization liquid, where the solvents contain an alcoholic solvent and an aromatic solvent. Moreover, the “polymerization liquid” refers to a “solution for polymerization” or a “mixture for polymerization.”

Another aspect of the invention provides a conductive polymer film obtained from a polymerization liquid that includes a π conjugated conductive polymer having a repeating unit of a monomer of a conductive polymer that is at least one kind selected from the group consisting of pyrroles, thiophenes, anilines, and derivatives thereof, an oxidizer, an alcoholic solvent, and an aromatic solvent contained in the polymerization liquid in the proportion of 1 to 50 percent by mass of the total solvent. The aromatic solvent contains, as a substituent group of an aromatic ring, an alkyl group with a carbon number ranging from 1 to 10 and/or an alkoxy group with a carbon number of 1 to 10, but lacks a hydroxyl group.

Yet another aspect of the invention provides an electronic device using the conductive polymer film obtained according to an embodiment.

Yet another aspect of the invention provides a method of forming a conductive polymer film including the steps of preparing a polymerization liquid containing monomers of a conductive polymer, an oxidizer, an alcoholic solvent, and an aromatic solvent in proportions of 1 to 50 percent by mass of the total solvent, the aromatic solvent containing, as a substituent group of an aromatic ring, an alkyl group (including a group bonded at two positions of an aromatic ring to form a ring structure) with a carbon number ranging from 1 to 10 and/or an alkoxy group with a carbon number of 1 to 10, but lacking a hydroxyl group, applying the polymerization liquid to a substrate, and drying the applied polymerization liquid and polymerizing the monomers of the conductive polymer to form the conductive polymer film.

According to embodiments, the conductive polymer film has an excellent conductivity because the doping rate and the orientation are improved.

According to embodiments, an electronic device comprising the aforementioned conductive polymer film may have enhanced performance.

According to a method, the conductive polymer film has an excellent conductivity because the doping rate and the orientation are improved.

### BRIEF DESCRIPTION OF THE DRAWINGS

FIG. 1 is a schematic sectional view of a solid electrolytic capacitor according to an embodiment.

FIG. 2 is schematic sectional view of an organic solar cell according to another embodiment.

FIG. 3 is a schematic sectional view of a transparent electrode according to another embodiment.

FIG. 4 is a schematic sectional view of a touch screen according to yet another embodiment.

### DETAILED DESCRIPTION OF EMBODIMENTS

Embodiments of the invention are explained with reference to the drawings. In the respective drawings referenced herein, the same constituents are designated by the same reference numerals and duplicate explanation concerning the same constituents is omitted. The drawings illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

Prepositions, such as “on,” “over” and “above” may be defined with respect to a surface, for example a layer surface, regardless of that surface's orientation in space. The preposition “above” may be used in the specification and claims even if a layer is in contact with another layer. The preposition “on” may be used in the specification and claims when a layer is not in contact with another layer, for example, when there is an intervening layer between them.

### <Aromatic Solvent>

According to an embodiment, an aromatic solvent is contained in a polymerization liquid in the proportion of 1 to 50 percent by mass of a total solvent, or is more preferably contained in the proportion of 10 to 30 percent by mass. The excellent electrical conductivity may not be obtained if too little aromatic solvent is in the polymerization liquid. In contrast, too much aromatic-solvent content sometimes lowers the electrical conductivity of the resultant conductive polymer film.

Each aromatic solvent contains an alkyl group with a carbon number of 1 to 10 (including a group bonded at two positions of an aromatic ring to form a ring structure) and/or an alkoxy group with a carbon number ranging from 1 to 10 as a substituent group of an aromatic ring, but lacks a hydroxyl group. More preferably, the carbon number of the alkyl group is 1 to 4. As described above, alkyl groups may be substituted at two different positions in the aromatic ring, and the alkyl group may form a ring structure. An example of such aromatic solvents is tetralin.

The carbon number of the alkoxy group is also 1 to 10, and more preferably 1 to 4.

The number of the substituent group substituted in an aromatic ring such as a benzene ring is preferably one to two.

The aromatic solvents in an embodiment lack a hydroxyl group. Unlike ordinary alcohols such as ethanol and butanol, aromatics with a hydroxyl group are not preferable additives. The reason is that aromatic phenoxide ions (C₆H₅O⁻) of their conjugated bases are stabilized by the resonance effect of the aromatic ring. And, aromatics of this kind show high acid dissociation constants, and function as acids that promote the polymerization reaction much further than necessary.

Benzene derivatives with the above-mentioned substituent groups are examples of aromatic solvents. Toluene, ethylbenzene, xylene, dodecylbenzene, and tetralin are some examples of the benzene derivatives with alkyl groups as substituent groups.

Anisole (methoxybenzene) and ethoxybenzene exemplify benzene derivatives with alkoxy groups as substituent groups. Of the possible aromatic solvents mentioned above, benzene derivatives with alkoxy groups as substituent groups, such as anisole (methoxybenzene) and ethoxybenzene are used preferably in view of their miscibility with other contents of the polymerization liquid as well as with the solvent.

<Monomer of conductive Polymer>
Pyrrole, thiophene, aniline and their derivatives exemplify conductive polymer monomers. A π conjugated conductive polymer with repeating units of the monomer is obtained by polymerizing such monomers. Hence, conductive polymers containing, for instance, polypyrroles, polythiophenes, polyanilines, or their copolymers can be obtained using the monomers mentioned above.

The π conjugated conductive polymers with no substituents may exhibit sufficient electrical conductivity by adding dopants. However, in order to further increase the electrical conductivity, or to get higher solubility of the conductive polymers, some functional groups may be introduced to the π conjugated conductive polymers. Alkyl groups, carboxylic groups, sulfonate groups, alkoxyl groups, hydroxyl groups, and cyano groups are some examples of the functional groups that are usable for the purpose.

Specific examples of the π conjugated conductive polymer include polypyrrole, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3,4-ethylenedioxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-anilinesulfonic acid), and poly(3-anilinesulfonic acid). Among those, a (co)polymer made of one kind or two kinds selected from polypyrrole, polythiophene, poly(N-methylpyrrole), poly(3-methylthiophene), poly(3-methoxythiophene), and poly(3,4-ethylenedioxythiophene) is preferably used from the viewpoint of electrical conductivity. Moreover, polypyrrole, and poly(3,4-ethylenedioxythiophene) are more preferable from the viewpoints of increased electrical conductivity and improved heat resistance.

### <Oxidizer>

In the embodiment, the oxidizer is used as a polymerization initiator for monomers of the conductive polymer. Transition metal compounds, such as iron(III) sulfate and iron(III) nitrate, and transition metal salts of organic sulfonic acid, such as iron p-toluenesulfonate, exemplify the oxidizer. The oxidizers that are preferably used function not only as a polymerization initiator but also as dopant to improve electrical conductivity.

### <Alcoholic Solvent>

The alcoholic solvent used in an embodiment is not limited to particular species unless the alcoholic solvent is compatible with the monomer of conductive polymer, the oxidizer, and/or the aromatic solvent. Examples of the alcoholic solvent are methanol, ethanol, propyl alcohol, butanol, pentanol, hexanol, ethylene glycol, and mixed alcohols of these. Above all, methanol, ethanol, propyl alcohol, butanol and mixed alcohols of these are preferred.

### <Additive>

Materials that function as dopants for the conductive polymer film may be added to the polymerization liquid in an embodiment. Specific exemplary materials include I₂⁻, Br₂⁻, ClO₄⁻, BF₄⁻, FeCl₄⁻, PF₆⁻, AsF₆⁻, SbF₆⁻ and sulfonic acid compounds (e.g., sulfuric acid, alkylbenzene sulfonic acid, alkylnaphthalene sulfonic acid, camphorsulfonic acid, polystyrene sulfonic acid, etc.) as dopants, and the salts containing both dopants and basic substances. Examples of salts effectively added to a polymerization liquid include pyridinium p-toluenesulfonate, 2-aminoethanethiol-p-toluenesulfonic acid salt, aminomalononitrile-p-toluenesulfonic acid salt, phenylalanine benzyl ester-p-toluenesulfonic acid salt, 2,6-dimethylpyridinium p-toluenesulfonate, 2,4,6-trimethylpyridinium p-toluenesulfonate, 2-chloro-1-methylpyridinium p-toluenesulfonate, 2-fluoro-1-methylpyridine-p-toluenesulfonate, pyridinium 3-nitrobenzenesulfonate, 1-cyclohexyl-3-(2-morpholinoethyl)carbodiimide metho-p-toluenesulfonate, glycine benzyl ester p-toluenesulfonate, hexyl 6-aminohexanoate p-toluenesulfonate, β-alanine benzyl ester p-toluenesulfonate, D-alanine benzyl ester p-toluenesulfonate, D-leucine benzyl ester p-toluenesulfonate, D-valine benzyl ester p-toluenesulfonate, L-alanine benzyl ester p-toluenesulfonate, L-leucine benzyl ester p-toluenesulfonate, L-tyrosine benzyl ester p-toluenesulfonate, propionyl p-toluenesulfonate, tetramethylammonium p-toluenesulfonate, tetraethylammonium p-toluenesulfonate, tosufloxacin p-toluenesulfonate, 1-ethyl-3-methylimidazolium p-toluenesulfonate, imidazolium salts, pyrrolidinium salts, pyridinium salts, and ammonium salts, phosphonium salts, and sulfonium salts.

### <Substrate>

In a method of forming the conductive polymer film according to an embodiment, the polymerization liquid is applied to a substrate. The substrate is not specifically limited as long as the substrate allows the conductive polymer film to form thereon. In the case of a device including a conductive polymer film, for instance, what is needed for the substrate is to serve as the base on which the conductive polymer film is formed. In the case of a solid electrolytic capacitor, the substrate may be an anode comprised of a porous body where a dielectric layer is formed.

The conductive polymer film is formed on the substrate by, for instance, applying, to the substrate, a polymerization liquid containing the monomer of the conductive polymer, the oxidizer, the alcoholic solvent, and the aromatic solvent, and thus polymerizing the monomer of the conductive polymer contained in the polymerization liquid. The method of applying the polymerization liquid to the substrate is not limited. Examples of such methods are spin coating, dip coating, drop casting, ink-jet methods, spraying, screen printing, gravure printing, and flexo printing.

### <Polymerization Liquid>

The polymerization liquid preferably contains a monomer of conductive polymer, the oxidizer, and the alcoholic solvent at amass ratio, for instance, ranging from 1:1:1 to 1:32:96 (monomer:oxidizer:solvent).

### <Solid Electrolytic Capacitor>

Solid electrolytic capacitors exemplify electronic devices using the conductive polymer film in an embodiment.

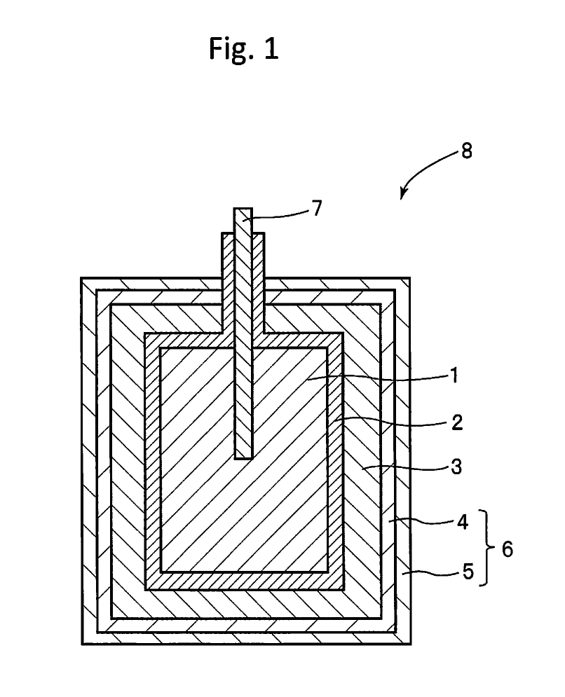

FIG. 1 is a schematic cross-sectional view illustrating a solid electrolytic capacitor, which is an example of the electronic device according to the embodiment.

As FIG. 1 shows, anode lead 7 is buried in anode 1. First, anode 1 is formed by molding metal particles of a valve metal or of an alloy including a valve metal as an essential ingredient. Then, the molded body is sintered. Accordingly, anode 1 is formed of a porous body. Although not shown in FIG. 1, many fine pores are formed in the porous body and continuously connected from the inside to the outside thereof. Anode 1 thus fabricated has a substantially rectangular parallelepiped shape. Examples of the valve metal are tantalum, niobium, titanium, aluminum, hafnium, zirconium, and the like. Above all, tantalum, niobium, aluminum, and titanium are especially preferable, because dielectric oxide is relatively stable even at high temperature. An example the alloy mainly containing a valve metal is an alloy containing two or more kinds of valve metals, such as tantalum and niobium.

Dielectric layer 2 containing an oxide is formed on a surface of anode 1. Dielectric layer 2 is formed also on wall surfaces of the pores of anode 1. FIG. 1 schematically shows dielectric layer 2 formed on the outer peripheral side of anode 1, but does not show the above-described dielectric layer formed on the wall surfaces of the pores of the porous body. Dielectric layer 2 can be formed by anodizing the surface of anode 1.

Conductive polymer layer 3 is formed on the surface of the dielectric layer 2. At least part of conductive polymer layer 3 can be made of the conductive polymer film of this embodiment. Conductive polymer layer 3 is formed also on dielectric layer 2 on the wall surfaces of the pores of anode 1.

Carbon layer 4 is formed on conductive polymer layer 3 on the outer peripheral surface of anode 1. Silver paste layer 5 is formed on carbon layer 4. Carbon layer 4 and silver paste layer 5 constitute cathode layer 6. Carbon layer 4 can be formed by applying a carbon paste, and then drying the carbon paste. Silver paste layer 5 can be formed by applying a silver paste, and then drying the silver paste.

Solid electrolytic capacitor 8 is constructed in the above-described manner. In general, solid electrolytic capacitor 8 is provided with a mold resin that covers the periphery of solid electrolytic capacitor 8. In addition, an anode terminal is connected to anode lead 7, and a cathode terminal is connected to cathode layer 6. Each of the terminals is led outside the mold resin.

In the embodiment, at least part of conductive polymer layer 3 is formed by conductive polymer film of the embodiment. Therefore, it is possible to form conductive polymer layer 3 having excellent electrical conductivity.

In the solid electrolytic capacitor of the embodiment, at least part of conductive polymer layer 3 is formed by the conductive polymer film of the embodiment. Accordingly, the ESR of solid electrolytic capacitors 8 may be lowered.

### <Organic Solar Cell>

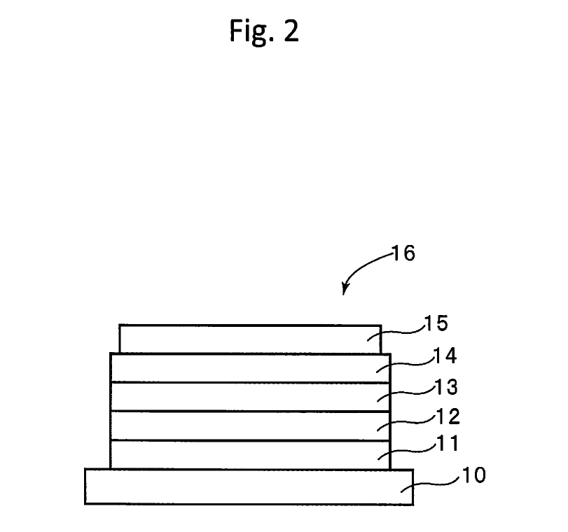

FIG. 2 is a schematic cross-sectional view illustrating an organic solar cell, which exemplifies an electronic device according to the embodiment.

As FIG. 2 shows, transparent electrode 11 is formed on substrate 10. A glass substrate can be used as substrate 10. A thin film containing indium-tin oxide (ITO) or the like is formed as transparent electrode 11.

Hole transporting layer 12 is formed on transparent electrode 11. The conductive polymer film of the embodiment is provided as hole transporting layer 12. Active layer 13 is formed on hole transporting layer 12. An example of active layer 13 is a poly(3-hexylthiophene) film. Electron transporting layer 14 is formed on active layer 13. For example, a film of C60 fullerene or the like may be formed as electron transporting layer 14.

Upper electrode 15 is formed on electron transporting layer 14. For example, a film of a metal such as aluminum may be formed as upper electrode 15.

Organic solar cell 16, which is an example of the embodiment, is constructed in the above-described manner.

In this exemplified organic solar cell, the conductive polymer film of the embodiment is used as hole transporting layer 12, so that it is possible to form hole transporting layer 12 with excellent electrical conductivity. Hence, hole transporting layer 12 may improve the electrical conductivity. Accordingly, the IR drop caused by the interface resistance and the bulk resistance may be reduced, and the open-circuit voltage of the solar cell may be increased.

### <Transparent Electrode and Touch Screen>

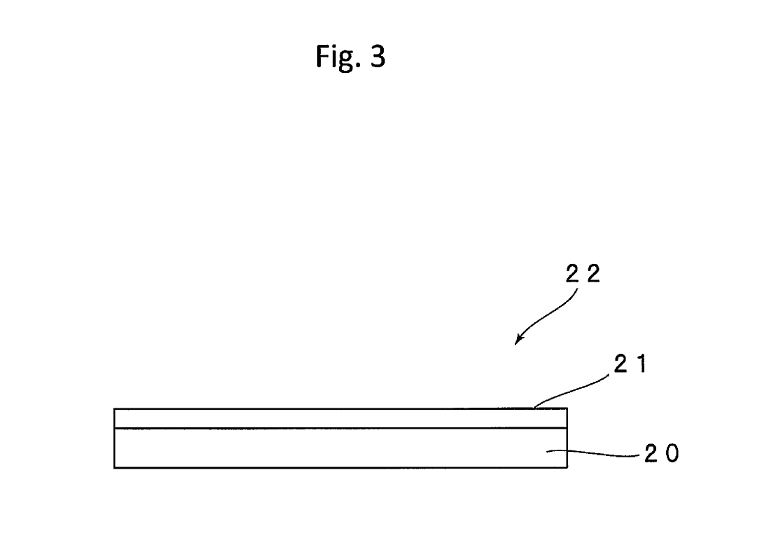

FIG. 3 is a schematic cross-sectional view illustrating a transparent electrode, which is another electronic device according to the embodiment. As FIG. 3 shows, conductive polymer film 21 is formed, as a transparent conductive film, on substrate 20. A plastic substrate or the like is used as substrate 20.

Transparent electrode 22 includes conductive polymer film 21 formed on substrate 20. In this example, the conductive polymer film of the embodiment is used as conductive polymer film 21. Hence, the electrical conductivity of conductive polymer film 21 may be improved. Accordingly, even if conductive polymer film 21 is thin, the light transmittance may be improved while maintaining certain surface resistance. In addition, the conductive polymer film of the embodiment has a small light absorption coefficient, and thus has excellent transparency. Also from this point of view, the transparency of conductive polymer film 21 can be improved.

Transparent electrode 22 of this example may be used, for instance, as a transparent electrode for touch screens, a transparent electrode for displays, and a transparent electrode for solar cells.

As a transparent electrode for displays, transparent electrode 22 of this example may be used as a transparent electrode for organic EL displays, liquid crystal displays, electronic papers, or the like. As a transparent electrode for solar cells, transparent electrode 22 of this example may be used as a transparent electrode for dye-sensitized solar cells, organic thin-film solar cells (organic solar cells), solar cells made of various compounds, solar cells of silicon-based materials, or the like.

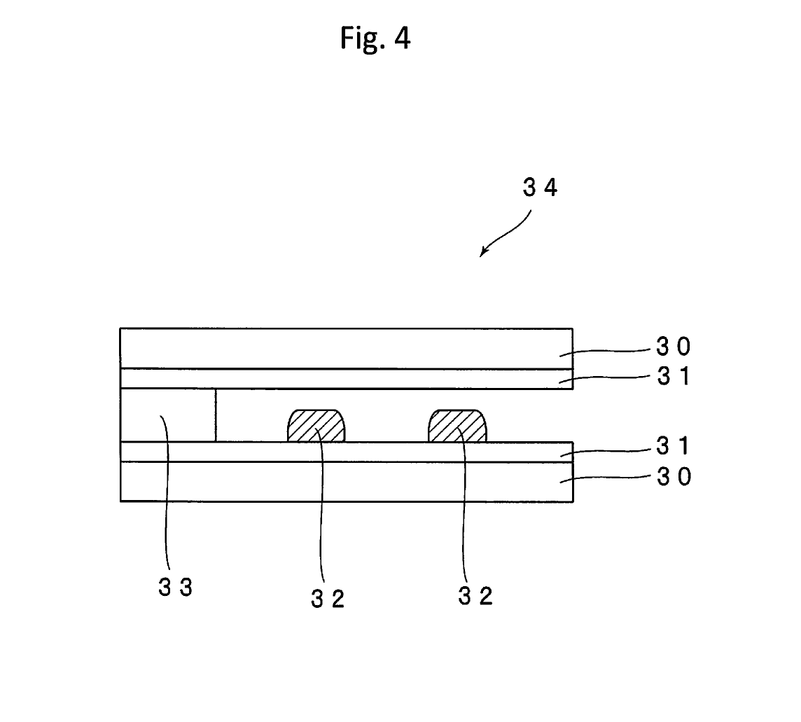

FIG. 4 is a schematic cross-sectional view illustrating a touch screen, which exemplifies an electronic device according to the embodiment. As FIG. 4 shows, one conductive polymer film 31 is formed on each of a pair of substrates 30, and the pair of substrates 30 are disposed in a manner that two conductive polymer films 31 face each other. Bonding agent 33 is provided between the pair of conductive polymer films 31. Multiple spacers 32 are provided on top of one of the pair of conductive polymer films 31. When one of the pair of substrate 30 is pressed, the distance between the pair of conductive polymer films 31 becomes narrower, and the spacers 32 are pressed. Hence, electric current flows between the pair of conductive polymer films 31, and thus the pair of conductive polymer films 31 become electrically connected.

In touch screen 34 of this example, conductive polymer film of the embodiment is used as conductive polymer film 31. Accordingly, conductive polymer film 31 has high electrical conductivity and favorable light transmittance.

### EXAMPLE

Hereinafter, the embodiment is described in more detail via specific examples. The embodiment is not limited to the following examples.

<Formation of Conductive Polymer film on Glass Substrate>

### Experiment 1

In Experiment 1, 3,4-ethylenedioxythiophene is used as the monomer of the conductive polymer. A butanol solution containing 50 percent by mass of iron (III) p-toluenesulfonate is used as the oxidizer. Pyridinium p-toluenesulfonate is used as the additive. Anisole (methoxybenzene) is used as the aromatic solvent. Firstly, 3,4-ethylenedioxythiophene (A), iron (III) p-toluenesulfonate (B), and pyridinium p-toluenesulfonate (C) are mixed together at the mixing ratios (mole ratio) A:B:C shown in Table 1, and then anisole is mixed in the resultant mixture. Anisole is mixed at the ratios shown in Table 1, where the ratios are shown in percent by mass of the anisole against the total mass of the butanol and anisole in the butanol solution.

The polymerization liquids prepared with the contents mixed in the above-described way are applied to glass substrates by the spin coating method to form films. Once the films are formed, the films are left at 50° C. for an hour. After that, the films are washed with pure water to remove by-products. Thus, conductive polymer films containing polyethylenedioxythiophene (PEDOT) are formed on glass substrates.

The thicknesses of the conductive polymer films thus obtained are measured to calculate the electrical conductivity. A constant area of each conductive polymer film is measured (specifically, an area of 2 cm×2 cm of each film is measured). A stylus-type surface-profile measurement instrument, Dektak is used to measure the thicknesses of the films, and a resistivity meter, Lorester MCP-T610 (manufactured by Dia Instruments Co. Ltd.) is used to measure the electrical conductivity of each conductive polymer film. A spectrophotometer, U4100 (manufactured by Hitachi High-Technologies Corporation) is used to measure the absorbance at the wavelength of 800 nm.

The number of revolutions in the spin coating process to apply each conductive polymer film is shown in Table 1. Table 1 also shows the thickness (thickness of PEDOT film), the absorbance, the sheet resistance, and the electrical conductivity of each conductive polymer film.

TABLE 1

| | | | Number of | | | | |
|---|---|---|---|---|---|---|---|
| | | | Revolutions | | | | |
| | | | in Spin | Thickness | | | |
| | Mixing | | Coating | of | | Sheet | Electrical |
| | Ratio | Aromatic | Process | PEDOT | Absorbance | Resistance | Conductivity |
| | A: B: C | Solvent | (rpm) | Film (Å) | (at 800 nm) | (Ω/square) | (S/cm) |
| Example 1 | 1:3.62:3.62 | 10% by mass | 1000 | 785 | 0.22688 | 89.9 | 1417 |
| | | Anisole | | | | | |
| Example 2 | 1:3.62:3.62 | 10% by mass | 2000 | 443 | 0.1292 | 136.3 | 1656 |
| | | Anisole | | | | | |
| Example 3 | 1:3.62:3.62 | 10% by mass | 3000 | 374 | 0.1025 | 168.3 | 1588 |
| | | Anisole | | | | | |
| Example 4 | 1:3.71:3.71 | 20% by mass | 1000 | 485 | 0.1376 | 124.1 | 1661 |
| | | Anisole | | | | | |
| Example 5 | 1:3.71:3.71 | 20% by mass | 2000 | 350 | 0.0875 | 169.9 | 1682 |
| | | Anisole | | | | | |
| Example 6 | 1:3.71:3.71 | 20% by mass | 3000 | 289 | 0.0594 | 255.6 | 1354 |
| | | Anisole | | | | | |
| Example 7 | 1:3.64:3.64 | 30% by mass | 1000 | 502 | 0.13561 | 123.4 | 1614 |
| | | Anisole | | | | | |
| Example 8 | 1:3.64:3.64 | 30% by mass | 2000 | 294 | 0.0727 | 207.3 | 1641 |
| | | Anisole | | | | | |
| Example 9 | 1:3.64:3.64 | 30% by mass | 3000 | 218 | 0.045 | 320.4 | 1432 |
| | | Anisole | | | | | |
| Comparative | 1:3.7:3.7 | — | 1000 | 799 | 0.3197 | 115.1 | 1086 |
| Example 1 | | | | | | | |
| Comparative | 1:3.7:3.7 | — | 2000 | 593 | 0.2370 | 143.4 | 1176 |
| Example 2 | | | | | | | |

As Table 1 shows, Examples 1 to 9, which use polymerization liquids prepared according to the embodiment by adding anisole as the aromatic solvent, show higher electrical conductivity than that of Comparative Examples 1 and 2 prepared without addition of any aromatic solvents. In addition, Examples 1 to 9 have lower absorbance than that of Comparative Examples 1 and 2, meaning that Examples 1 to 9 have favorable light transmittance.

As has been described above, a conductive polymer film with higher electrical conductivity and favorable light transmittance can be formed according to the embodiment.

### Experiment 2

Polymerization liquids are prepared in the same manner as in Experiment 1. Experiment 2, however, differs from Experiment 1 both in the use of ethoxybenzene, toluene, xylene, n-butylbenzene, and tetralin as the aromatic solvents and in the use of the mixing molar ratios A:B:C shown in Table 2. Conductive polymer films are formed on glass substrates by using the polymerization liquids thus prepared.

For comparative purposes, polymerization liquids are prepared in the same manner as described above, but with either ethylene glycol or m-cresol instead of the aromatic solvent of the embodiment. Conductive polymer films are formed on glass substrates using the polymerization liquids thus prepared.

The number of revolutions in the spin coating process to apply each conductive polymer film is shown in Table 2. Table 2 also shows the thickness (thickness of PEDOT film), the sheet resistance, and the electrical conductivity of each conductive polymer film.

In Comparative Example 4, in which the polymerization liquid prepared with m-cresol, the polymerization liquid starts to change its color immediately after the addition of m-cresol to the polymerization liquid. In addition, in the spin coating process, the thin film starts to have more coloring than in the other cases from the time immediately after the spin coating. A possible reason for this phenomenon is that the hydroxyl group contained in the m-cresol polymerization liquid interacts, in some way or other, with other contents in the polymerization liquid.

TABLE 2

| | | | Number of | | | |
|---|---|---|---|---|---|---|
| | | | Revolutions | | | |
| | | | in Spin | | | |
| | Mixing | | Coating | Thickness | Sheet | Electrical |
| | Ratio | Aromatic | Process | of PEDOT | Resistance | Conductivity |
| | A: B: C | Solvent | (rpm) | Film (Å) | (Ω/square) | (S/cm) |
| Example 10 | 1:4.0:4.0 | 10% by mass | 1000 | 750 | 95 | 1404 |
| | | Ethoxybenzene | | | | |
| Example 11 | 1:4.0:4.0 | 10% by mass | 2000 | 400 | 160 | 1562 |
| | | Ethoxybenzene | | | | |
| Example 12 | 1:4.0:4.0 | 20% by mass | 1000 | 510 | 133 | 1474 |
| | | Ethoxybenzene | | | | |
| Example 13 | 1:4.0:4.0 | 20% by mass | 2000 | 320 | 210 | 1488 |
| | | Ethoxybenzene | | | | |
| Example 14 | 1:4.0:4.0 | 10% by mass | 2000 | 610 | 132 | 1241 |
| | | Toluene | | | | |
| Example 15 | 1:4.0:4.0 | 10% by mass | 2000 | 530 | 136 | 1387 |
| | | Xylene | | | | |
| Example 16 | 1:4.0:4.0 | 10% by mass | 2000 | 360 | 214 | 1298 |
| | | N-butylbenzene | | | | |
| Example 17 | 1:4.0:4.0 | 10% by mass | 2000 | 290 | 288 | 1197 |
| | | Tetralin | | | | |
| Comparative | 1:4.0:4.0 | 10% by mass | 2000 | 520 | 217 | 886 |
| Example 3 | | Ethylene | | | | |
| | | Glycol | | | | |
| Comparative | 1:4.0:4.0 | 10% by mass | 2000 | 675 | 327 | 453 |
| Example 4 | | M-cresol | | | | |

Anisole has a structure shown below, and has a boiling point of 154° C.

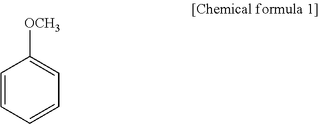

Ethoxybenzene has a structure shown below, and has a boiling point of 169° C.

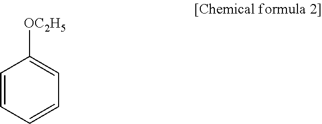

Toluene has a structure shown below, and has a boiling point of 111° C.

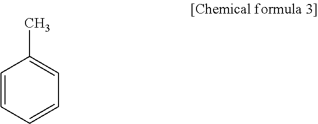

Xylene has a structure shown below, and has a boiling point of 139° C.

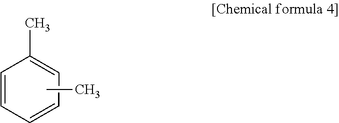

N-butylbenzene has a structure shown below, and has a boiling point of 183° C.

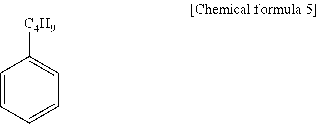

Tetralin has a structure shown below, and has a boiling point of 207° C.

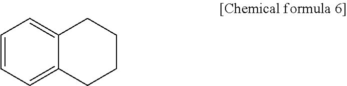

Ethylene glycol has a structure shown below, and has a boiling point of 197° C.

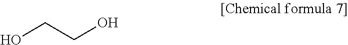

M-cresol has a structure shown below, and has a boiling point of 202° C.

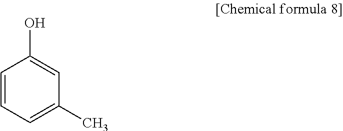

The results in Table 2 clearly show that even in the cases where ethoxybenzene, toluene, xylene, n-butylbenzene, and tetralin are used as aromatic solvents, the obtained conductive polymer films exhibit high conductivity.

In contrast, high electrical conductivity is not achieved in Comparative Example 3 where ethylene glycol, which is not an aromatic solvent, is used. Likewise, high electrical conductivity is not achieved either in Comparative Example 4 where an aromatic solvent containing hydroxyl group is used.

The results in Tables 1 and 2 clearly show that a conductive polymer film with high electrical conductivity can be obtained by forming the conductive polymer film in such a way that the polymerization liquid is provided with an aromatic solvent containing an alkyl group and/or an alkoxy group with a carbon number ranging from 1 to 10, preferably from 1 to 4, as a substituent group of the aromatic ring, but containing no hydroxyl group. In addition, if an aromatic solvent containing an alkoxy group as the substituent group is used, higher electrical conductivity is obtained than in the case of an aromatic solvent containing an alkyl group as the substituent group.

In addition, the boiling point of the aromatic solvent preferably ranges from 111° C. to 207° C., and more preferably ranges from 139° C. to 183° C.

### <Fabrication of Solid Electrolytic Capacitor>

A solid electrolytic capacitor with a structure shown in FIG. 1 is fabricated. Anode 1 is formed of a sintered body of tantalum (Ta) powder. Anode 1 has a rectangular parallelepiped shape of dimensions 4.4 mm×3.2 mm×0.9 mm. Anode lead 7 is buried in an end surface (3.2 mm×0.9 mm) of anode 1 of the rectangular parallelepiped shape. Anode lead 7 is formed by tantalum (Ta).

Anode 1 with buried anode lead 7 is dipped into a phosphoric-acid aqueous solution kept at a temperature of 65° C., and is anodized for 10 hours by applying a constant voltage of 10 V. Thus dielectric layer 2 is formed on a surface of anode 1. As described earlier, dielectric layer 2 is also formed on the wall surfaces of the pores formed in the porous body of anode 1.

Then, anode 1 with dielectric layer 2 formed therein is dipped in a polymerization liquid. The polymerization liquid is prepared by firstly mixing 3,4-ethylenedioxythiophene as the monomer of the conductive polymer and iron (III) p-toluenesulfonate as the oxidizer at a molar ratio (the monomer of the conductive polymer:the oxidizer) of 1:4, and then further mixing anisole as the aromatic solvent. The iron(III) p-toluenesulfonate is provided as a butanol solution containing 50 percent by mass of iron (III) p-toluenesulfonate. The anisole thus mixed is 10 percent by mass of the total mass of the anisole and the butanol contained in the solution.

Conductive polymer layer 3 is formed on dielectric layer 2 of the anode 1 by firstly dipping the anode in the polymerization liquid. Then anode 1 is pulled out of the polymerization liquid and dried. Conductive polymer layer 3 is formed with a thickness of 50 μm by repeatedly dipping and drying anode 1 in the polymerization liquid.

Then, cathode layer 6 is formed by forming carbon layer 4 and then silver paste layer 5 on conductive polymer layer 3 on the peripheral surface of anode 1.

An anode terminal is welded to anode lead 7 of solid electrolytic capacitor 8 fabricated in the above-described manner. A cathode terminal is connected to the cathode layer 6 with an electrically conductive adhesive. Then, epoxy resin is used to mold the outer sides of solid electrolytic capacitor 8, and thereby coats and completely seals the solid electrolytic capacitor.

The ESR is measured for the solid electrolytic capacitor obtained in the above-described manner.

ESR is measured using an LCR meter (inductance-capacitance-resistance measuring apparatus) at a frequency of 100 kHz.

The ESR thus measured is 6.0 mg).

For comparative purposes, a comparative solid electrolytic capacitor is fabricated using a conductive polymer film that is formed in the same manner as the one described above except that a polymerization liquid with no added anisole is used as the aromatic solvent. The ESR of this comparative solid electrolytic capacitor is measured in the similar manner to the one described above. The ESR thus measured is 7.0 mΩ.

As described above, the electrical conductivity of conductive polymer layer 3 may be improved by using the conductive polymer film of the embodiment as the conductive polymer layer in the solid electrolytic capacitor. Hence, according to the embodiment, the ESR may be lowered.

### <Fabrication of Organic Solar Cells>

An organic solar cell with a structure shown in FIG. 2 is fabricated. The surface of transparent electrode 11 made of ITO is spin-coated with a polymerization liquid. The polymerization liquid used in the above-described fabrication of the solid electrolytic capacitor is also used in the fabrication of the organic solar cell. Then, the resultant transparent electrode 11 is left at a temperature of 50° C. for an hour. Then, the resultant transparent electrode is washed with pure water and dried to form hole transporting layer 12. Hence, hole transporting layer 12 is formed by a thin film having a 50-nm thickness layer comprising polyethylenedioxythiophene.

Subsequently, the surface of hole transporting layer 12 is spin-coated with an o-dichlorobenzene solution of poly (3-hexylthiophene) to form active layer 13 with a 50-nm thickness.

A film of C60 fullerene is vacuum-deposited on active layer 13, and thus electron transporting layer 14 with 50-nm thickness is formed.

Subsequently, using a shadow mask, an Al film is vacuum-deposited on electron transporting layer 14 to form upper electrode 15. Then, a glass cap is used to seal and thus complete organic solar cell 16. The organic solar cell thus fabricated is irradiated with artificial sunlight of AM 1.5 (100 mW/cm²), and an electromotive force of 0.6 V is obtained as an open-circuit voltage.

For comparative purposes, a comparative organic solar cell is fabricated using hole transporting layer 12 that is formed in the same manner as described above except that a polymerization liquid with no addition of anisole as the aromatic solvent is used.

This comparative organic solar cell is irradiated with artificial sunlight, and an electromotive force of 0.1 V is obtained as an open-circuit voltage.

As a consequence, by forming a conductive polymer film according to the embodiment hole transporting layer 12, the electrical conductivity of hole transporting layer 12 may be improved, and thus, the IR drop due to the interface resistance and the bulk resistance may be lowered, and the open-circuit voltage of the organic solar cell can be increased.

### <Fabrication of Transparent Electrode for Touch Screen>

A film is formed by applying, to a plastic substrate containing polyethersulfone (PES), the same polymerization liquid as the one used in the above-described fabrication of the solid electrolytic capacitor by the spin coating method. Then, the resultant film is left at a temperature of 50° C. for an hour. Then, the resultant film is washed with pure water to remove by-products. Hence, a conductive polymer film is formed on the substrate.

The conductive polymer film thus obtained has sheet resistance of 200 Ω/square and light transmittance of 90%. The light transmittance is calculated by obtaining average transmittance for light of various wavelengths ranging from 400 nm to 800 nm.

For comparative purposes, a conductive polymer film with the same thickness is formed using a polymerization liquid with no addition of anisole as the aromatic solvent. The sheet resistance and the light transmittance of this comparative conductive polymer film are measured. The measured sheet resistance is 305 Ω/square, and the measured light transmittance is 77%.

As a consequence, if a transparent electrode is formed using the conductive polymer film provided according to the embodiment, the transparent electrode thus formed may have low sheet resistance and high light transmittance.

As explained above, the conductive polymer film according to the embodiment is obtained through polymerization of the monomers in a polymerization liquid containing the above-mentioned aromatic solvent that is contained by 1-50 percent by mass of the total solvent. Further, by including the above-mentioned aromatic solvent in the polymerization liquid, the drying speed of the polymerized monomers may be moderated upon application of the polymerization liquid on to a substrate. This way, the polymerizing reaction process is controlled. Consequently, the doping ratio and the orientation of the conductive polymer may be improved, and the resultant conductive polymer film can have a high conductivity. Also, according to the embodiment, non-uniform evaporation of the solvents from the polymerization liquid may be prevented so that a more highly-uniform conductive polymer film may be obtained. The self-reactiveness of such a polymerization liquid may be moderated. As a result, the method for forming the conductive polymer film having a long pot life and excellent controllability may be provided.

The electronic device using the conductive polymer film according to the embodiment may have enhanced performance.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the claimed invention.

What is claimed is:

1. A conductive polymer film prepared from a polymerization liquid comprising:
monomers of a conductive polymer;
an oxidizer;
an alcoholic solvent; and
an aromatic solvent in the proportion of 1 to 50 percent by mass of the total solvent for polymerization, wherein the aromatic solvent comprises an aromatic ring with at least one constituent selected from an alkyl group with a carbon number of 1 to 10 and/or an alkoxy group with a carbon number of 1 to 10, but lacking a hydroxyl group.

2. The conductive polymer film of claim 1, wherein the aromatic solvent is selected from the group consisting of alkoxybenzenes, alkylbenzenes, tetralins, and derivatives thereof.

3. The conductive polymer film of claim 1, wherein the number of constituent groups of the aromatic ring is 1 or 2.

4. The conductive polymer film of claim 1, wherein the carbon number of the alkyl group ranges from 1 to 4.

5. The conductive polymer film of claim 1, wherein the alkyl group is bonded at two positions of an aromatic ring to form a ring structure.

6. The conductive polymer film of claim 1, wherein the carbon number of the alkoxy group ranges from 1 to 10.

7. The conductive polymer film of claim 1, wherein the carbon number of the alkoxy group ranges from 1 to 4.

8. The conductive polymer film of claim 1, wherein the oxidizer is a transition metal compound or a transition metal salt.

9. The conductive polymer film of claim 1, wherein the polymerization liquid contains a dopant as an additive.

10. The conductive polymer film of claim 1, wherein the polymerization liquid contains the monomer of the conductive polymer, the oxidizer, and the alcoholic solvent in a mass ratio ranging from 1:1:1 to 1:32:96 (monomer:oxidizer:solvent).

11. The conductive polymer film of claim 1, wherein the monomer of the conductive polymer is selected from the group consisting of pyrroles, thiophenes, anilines, and derivatives thereof.

12. The conductive polymer film of claim 1, wherein the polymerization liquid contains an aromatic solvent in the proportion of 10 to 30 percent by mass of the total solvent for polymerization, the aromatic solvent comprising an aromatic ring with at least one constituent selected from an alkyl group with a carbon number ranging from 1 to 10, and/or an alkoxy group with a carbon number ranging from 1 to 10, but lacking an hydroxyl group.

13. A conductive polymer film obtained from a polymerization liquid that comprises:
a π conjugated conductive polymer having a repeating unit of a monomer of a conductive polymer selected from the group consisting of pyrroles, thiophenes, anilines, and derivatives thereof;
an oxidizer;
an alcoholic solvent; and
an aromatic solvent contained in the polymerization liquid in the proportion of 1 to 50 percent by mass of the total solvent for polymerization, the aromatic solvent comprising an aromatic ring with at least one constituent selected from an alkyl group with a carbon number ranging from 1 to 10 and/or an alkoxy group with a carbon number ranging from 1 to 10, but lacking a hydroxyl group.

14. The conductive polymer film of claim 10, wherein the π conjugated conductive polymer comprises a constituent selected from the group consisting of alkyl group, carboxylic group, sulfonate group, alkoxyl group, hydroxyl group, and cyano group.

15. An electronic device using the conductive polymer film of claim 1.

16. The electronic device of claim 15 selected from the group consisting of:
a solid electrolytic capacitor;
an organic solar cell;
a transparent electrode; and
a touch screen.

17. A method of forming a conductive polymer film comprising the steps of:
preparing a polymerization liquid containing monomers of a conductive polymer, an oxidizer, an alcoholic solvent, and an aromatic solvent in a proportion of 1 to 50 percent by mass of the total solvent for polymerization, the aromatic solvent comprising an aromatic ring with at least one constituent selected from an alkyl group with a carbon number ranging from 1 to 10, an alkyl group bonded at two positions of the aromatic ring to form a ring structure, and/or an alkoxy group with a carbon number ranging from 1 to 10, but lacking a hydroxyl group;
applying the polymerization liquid to a substrate; and
drying the applied polymerization liquid and polymerizing the monomers of the conductive polymer to form the conductive polymer film.

18. The method of forming a conductive polymer film of claim 17, wherein the step of applying the polymerization liquid to a substrate is performed by any of a spin coating method, a dip coating method, a drop casting method, an ink-jet method, a spray method, a screen printing method, a gravure printing method, and a flexo printing method.
